(19) United States
(12) Patent Application Publication
(10) Pub. No.: US 2026/0106196 A1
(43) Pub. Date: Apr. 16, 2026

(54) HYDROGEN GENERATION APPARATUS AND INFORMATION MANAGEMENT SYSTEM

(71) Applicant: CANON KABUSHIKI KAISHA, Tokyo (JP)

(72) Inventor: KEIJI KARUBE, Ibaraki (JP)

(21) Appl. No.: 19/419,307

(22) Filed: Dec. 15, 2025

Related U.S. Application Data
(63) Continuation of application No. PCT/JP2024/018954, filed on May 23, 2024.

(30) Foreign Application Priority Data
Jun. 27, 2023 (JP) 2023-104628

(51) Int. Cl. H01M 8/0606; G01N 35/00

(52) U.S. Cl. CPC H01M 8/0606; G01N 35/00732; H01M 2250/30

(57) ABSTRACT

A hydrogen generation unit generates hydrogen by reacting a hydrogen carrier with a water-containing liquid. A main body includes the hydrogen generation unit. A collection container is attachable to and detachable from the main body, and collects a composition containing a byproduct generated together with hydrogen in the hydrogen generation unit. A detection unit detects a collected amount of the composition collected from the hydrogen generation unit by the collection container. A storage unit is provided on the collection container and stores information regarding the collected amount.

### CROSS-REFERENCE TO RELATED APPLICATIONS

This application is a Continuation of International Patent Application No. PCT/JP2024/018954, filed May 23, 2024, which claims the benefit of Japanese Patent Application No. 2023-104628, filed Jun. 27, 2023, both of which are hereby incorporated by reference herein in their entirety.

### BACKGROUND

### Field of the Technology

The present disclosure relates to a hydrogen generation apparatus that generates hydrogen, and an information management system including the hydrogen generation apparatus.

### Description of the Related Art

As a hydrogen generation apparatus, there has been proposed a hydrogen generation apparatus including a detachable fuel cartridge, the fuel cartridge including a memory unit that stores a remaining amount of supplied water or a remaining amount of hydrogen capable of being generated (WO 2010/026945 A).

### SUMMARY

However, in a hydrogen generation apparatus using a metal hydride such as sodium borohydride as a fuel, a composition (reaction product) containing a byproduct such as sodium metaborate is also generated at the time of hydrogen generation. Such a composition is collected in a collection container. Here, in the case of the configuration described in Patent Literature 1, it is possible to grasp a replacement timing of the fuel cartridge from the remaining amount of supplied water or the remaining amount of hydrogen capable of being generated, but the replacement timing of the collection container is unknown.

The present disclosure is to provide a configuration capable of grasping a collected amount in a collection container for collecting a composition containing a byproduct generated at the time of hydrogen production.

According to a first aspect of the present disclosure, a hydrogen generation apparatus includes a hydrogen generation unit configured to generate hydrogen by reacting a hydrogen carrier with a water-containing liquid, a main body including the hydrogen generation unit, a collection container being attachable to and detachable from the main body and configured to collect a composition containing a byproduct generated together with hydrogen in the hydrogen generation unit, a detection unit configured to detect a collected amount of the composition collected from the hydrogen generation unit by the collection container, and, a storage unit provided on the collection container and stores information regarding the collected amount.

According to a second aspect of the present disclosure, an information management system includes a hydrogen generation apparatus configured to generate hydrogen, and, an information collection apparatus being communicably connected to the hydrogen generation apparatus. The hydrogen generation apparatus includes a hydrogen generation unit configured to generate hydrogen by reacting a hydrogen carrier with a water-containing liquid, a main body including the hydrogen generation unit, a collection container being attachable to and detachable from the main body and collects a composition containing a byproduct generated together with hydrogen in the hydrogen generation unit, an identification information portion provided on the collection container, the identification information portion being information regarding identification of the collection container, a detection unit configured to detect a collected amount of the composition collected from the hydrogen generation unit by the collection container, and, a transmission unit configured to transmit information regarding the collected amount and the information regarding identification of the collection container, The information collection apparatus includes a reception unit configured to receive the information transmitted from the transmission unit, and a storage unit configured to store the information regarding the collected amount in association with the collection container based on the information received by the reception unit.

Features of the present disclosure will become apparent from the following description of embodiments with reference to the attached drawings.

### BRIEF DESCRIPTION OF THE DRAWING

FIG. 1 is a schematic configuration diagram of a hydrogen generation apparatus according to a first embodiment.

FIG. 2 is a schematic configuration diagram of an information management system according to a second embodiment.

### DESCRIPTION OF THE EMBODIMENTS

### First Embodiment

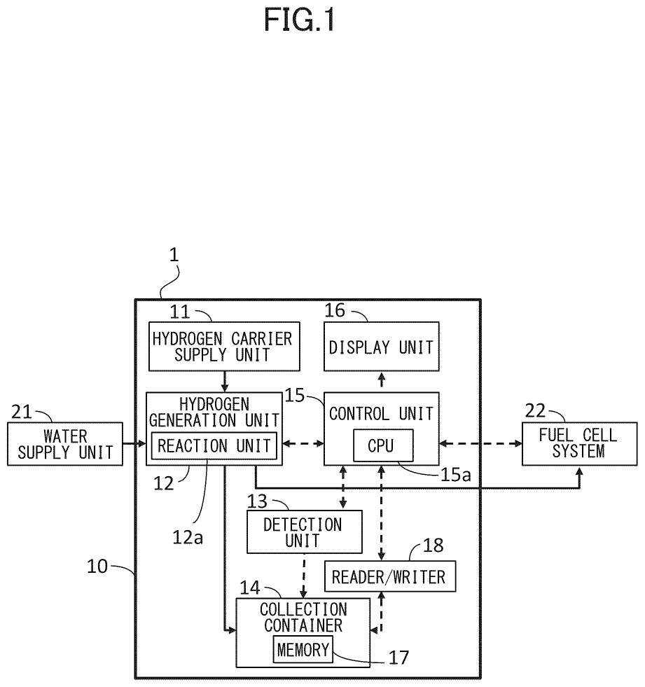

A first embodiment will be described with reference to FIG. 1. First, hydrogen has attracted attention as an energy source replacing fossil fuels. This is because hydrogen does not generate carbon dioxide or the like, which is a kind of greenhouse gas leading to global warming, at the time of combustion, unlike fossil fuels. A fuel cell vehicle is one of systems that have been put into practical use as a system using hydrogen as an energy source. The fuel cell vehicle is an automobile that generates electricity using hydrogen as a raw material and travels by operating an electric motor with the generated electricity. In many fuel cell vehicles, hydrogen serving as an energy source is stored in a hydrogen tank, and hydrogen from the hydrogen tank is put into a fuel cell to generate electricity. The hydrogen tank compresses and stores hydrogen at a high pressure, for example, 70 MPa (700 times the atmospheric pressure).

A problem of hydrogen serving as an energy source is that an energy density is low. A volumetric energy density of hydrogen is about 1/3000 of that of gasoline, and even if a hydrogen tank of 70 MPa is used, only about ⅕ of energy of gasoline can be extracted from the same volume. Therefore, in general, the fuel cell vehicle using the hydrogen tank is required to refuel more frequently than an automobile using gasoline.

For this reason, various substances have been studied as substances (that is, hydrogen carriers) capable of carrying hydrogen at a higher energy density than that of the hydrogen tank. For example, ammonia, methylcyclohexane, and borohydrides such as sodium borohydride are known as the hydrogen carriers, and the hydrogen carrier is transported instead of transporting hydrogen itself, and hydrogen is extracted from the hydrogen carrier at the time of use.

### [Hydrogen Carrier]

Among the hydrogen carriers, metal hydrides such as sodium borohydride, from which hydrogen can be easily extracted by applying water, are widely known. As a method for obtaining hydrogen by hydrolyzing sodium borohydride, a method in which sodium borohydride is dissolved in water and used as an aqueous solution has been known. However, in the method, theoretically, a larger amount of water than a required amount indicated by a reaction formula is required, and there is a problem that a substantial volumetric energy density decreases. Therefore, in the present embodiment, as described below, a water-containing liquid is applied to the hydrogen carrier in the hydrogen generation apparatus (specifically, a water-containing liquid is applied to the hydrogen carrier) to generate hydrogen.

Examples of the hydrogen carrier that generates hydrogen by being applied with the water-containing liquid include the following. For example, one or a mixture of two or more of solid metal hydrides such as sodium borohydride, potassium borohydride, lithium borohydride, zinc borohydride, lithium aluminum hydride, sodium aluminum hydride, magnesium aluminum hydride, calcium aluminum hydride, magnesium hydride, lithium hydride, sodium hydride, and calcium hydride, and metallic powders such as aluminum, zinc, calcium, and magnesium can be used. Additives such as a reaction accelerator and a desiccant may be used together with the hydrogen carrier.

The hydrogen carrier of the present embodiment may be a solid or a liquid, and is not particularly limited. However, the hydrogen carrier is preferably a solid. As the solid hydrogen carrier, a powdered or granular solid is desirable, but a solid in the form of a sheet, a pellet, or a paste may also be used. As the powdered solid, a powdered solid having a particle diameter of about 10 μm or more and 10 mm or less can be used, a powdered solid having a particle diameter of about 10 μm or more and 3 mm or less is preferable, and a powdered solid having a particle diameter of about 10 μm or more and 100 μm or less is more preferable. In addition, in a case where the solid in the form of a sheet or a pellet is used, it is preferable to increase a surface area by roughening the surface and performing a porosification treatment or the like to increase a contact area with the water-containing liquid from the viewpoint of enhancing reactivity with the water-containing liquid.

The hydrogen carrier of the present embodiment is a hydrogen carrier that generates a byproduct (reaction product) other than hydrogen, such as a liquid byproduct, a gel byproduct, or a solid byproduct, after generating hydrogen by a chemical reaction.

In the present embodiment, powdered sodium borohydride having an average particle diameter of 50 μm was used as the solid hydrogen carrier. The powdered sodium borohydride reacts with water to generate hydrogen. The reacted sodium borohydride is changed into sodium metaborate as the byproduct. Water that was not used in the reaction remains. The reaction is represented by the following chemical formula.

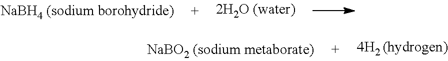

It is known that the reaction (Chemical Formula (1)) is promoted by a Raney catalyst formed of a metal such as nickel, cobalt, or copper, or an acidic solution such as citric acid or acetic acid. In the present embodiment, a larger amount of water than in Formula (1) is supplied in order to efficiently conduct a hydrolysis reaction throughout the entire hydrogen carrier, as a result of which the byproduct is a liquid sodium metaborate solution.

### [Water-Containing Liquid]

The “water-containing liquid” in the present embodiment only needs to be a liquid that reacts with the hydrogen carrier when applied with liquid to generate hydrogen, and is not particularly limited. That is, the water-containing liquid may be water alone. Two or more types of water-containing liquids may be prepared. A hydrogen generation rate can be adjusted by preparing two or more types of water-containing liquids.

The water-containing liquid can contain a water-soluble organic solvent. Examples of the water-soluble organic solvent include alcohols, polyalkylene glycols, glycol ethers, nitrogen-containing compounds, and sulfur-containing compounds. A mixture of two or more selected therefrom may be used. As the water-containing liquid contains the water-soluble organic solvent, the reaction with the hydrogen carrier can be optimized by adjusting a surface tension and adjusting a boiling point and a melting point of the water-containing liquid.

A surfactant can be added to the water-containing liquid. By using the surfactant, the surface tension of the water-containing liquid can be reduced, a contact area with the hydrogen carrier can be increased, so that an efficient reaction can be performed.

The water-containing liquid can contain a water-soluble acidic substance. The acidic substance acts as a positive catalyst in the reaction between the water-containing liquid and the hydrogen carrier. The hydrogen generation rate can be adjusted by adjusting an amount of the liquid containing the acidic substance. In particular, the hydrogen generation rate can be increased by setting the pH obtained by the water-containing liquid and the hydrogen carrier to less than 9.0. Examples of the acidic substance include, but are not limited to, various acids such as hydrochloric acid, sulfuric acid, nitric acid, boric acid, and organic acid.

The water-containing liquid can contain a water-soluble basic substance. The basic substance acts as a negative catalyst in the reaction between the water-containing liquid and the hydrogen carrier. The hydrogen generation rate can be adjusted by adjusting an amount of the liquid containing the basic substance. In particular, the hydrogen generation rate can be decreased by setting the pH obtained by the water-containing liquid and the hydrogen carrier to 9.0 or more. Examples of the basic substance include, but are not limited to, various bases such as sodium hydroxide, potassium hydroxide, and aqueous ammonia.

The water-containing liquid can contain a buffer solution. The buffer solution functions to suppress a pH change in the reaction between the water-containing liquid and the hydrogen carrier. The hydrogen generation rate can be adjusted by adjusting an amount of the liquid containing the buffer solution. Examples of the buffer solution include, but are not limited to, various buffer solutions such as a phosphate buffer solution, a glycine buffer solution, a Good's buffer solution, a tris buffer solution, and an ammonia buffer solution.

The water-containing liquid may contain various additives such as an antifoaming agent, a pH adjuster, a viscosity modifier, a rust inhibitor, a preservative, an antifungal agent, an antioxidant, and a reduction inhibitor in addition to the above components as necessary.

### [Hydrogen Generation Apparatus]

A hydrogen generation apparatus 1 of the present embodiment will be described with reference to FIG. 1. FIG. 1 is a block diagram schematically illustrating a schematic configuration of the hydrogen generation apparatus 1 of the present embodiment. In the figure, a solid line indicates exchange of a tangible substance such as hydrogen carrier, water, or hydrogen, and a dotted line indicates exchange of an intangible element such as information or a signal.

The hydrogen generation apparatus 1 includes a main body 10, a hydrogen carrier supply unit 11, a hydrogen generation unit 12, a detection unit 13, a collection container 14, a control unit 15, and a display unit 16. A water supply unit 21 and a fuel cell system 22 are connected to the hydrogen generation apparatus 1 as external mechanisms. Hereinafter, the hydrogen generation apparatus 1 using, as a fuel, the powdered sodium borohydride serving as the hydrogen carrier will be described.

In the hydrogen generation apparatus 1, the hydrogen generation unit 12 mixes the water-containing liquid supplied from the water supply unit 21 serving as the external mechanism with the hydrogen carrier supplied from the hydrogen carrier supply unit 11, and causes a hydrolysis reaction to generate hydrogen and the byproduct. The control unit 15 is for controlling conditions such as an amount of the hydrogen generated in the hydrogen generation unit 12, an amount of the hydrogen carrier supplied from the hydrogen carrier supply unit 11, an amount of the water-containing solution, and a reaction rate. In the present embodiment, the amount of the supplied hydrogen carrier and the amount of the supplied water-containing solution can be adjusted by the hydrogen generation unit 12 through the control unit 15.

The hydrogen generated in the hydrogen generation unit 12 is sent to the fuel cell system 22 serving as the external mechanism. The fuel cell system 22 generates electricity by using the hydrogen generated by the hydrogen generation unit 12, and exemplifies an apparatus that uses the hydrogen generated by the hydrogen generation apparatus 1. A composition containing the byproduct (reaction product) (a liquid containing the byproduct and unreacted water in the present embodiment) generated at the time of hydrogen generation is collected in the collection container 14.

The detection unit 13 detects the amount of the composition containing the byproduct in the collection container 14. That is, the amount of the liquid containing the byproduct and unreacted water, which is sent to the collection container 14, is collectively measured by the detection unit 13 as a composition containing the byproduct, and sent to the control unit 15 as information together with a reaction ratio between the hydrogen carrier and the water-containing solution in the hydrogen generation unit 12. The information is computed by the control unit 15, and is stored in a memory 17, which is a nonvolatile memory attached to the collection container 14, with information such as a collected amount in the collection container 14 and the amount of the byproduct.

In addition, the display unit 16 displays information regarding the collected amount in the collection container 14, such as the remaining collection capacity in the collection container 14 and an OVER state of the collected amount. In the present embodiment, in consideration of a storage capacity of the collection container 14, the collected amount and information indicating that the collected amount is close to the OVER state are sent to the display unit 16 and displayed on the display unit 16. Hereinafter, each configuration and function of the hydrogen generation apparatus 1 will be described in more detail based on the block diagram of FIG. 1.

### [Main Body]

In the main body 10, the hydrogen carrier supply unit 11, the hydrogen generation unit 12, the detection unit 13, the collection container 14, the control unit 15, and the display unit 16 described above are installed. As described below, the collection container 14 is attachable to and detachable from the main body 10. The hydrogen carrier supply unit 11 may also be attachable to and detachable from the main body 10.

### [Hydrogen Carrier Supply Unit]

The hydrogen carrier supply unit 11 is a container capable of storing the hydrogen carrier, and is a container attachable to and detachable from the hydrogen generation apparatus 1. The hydrogen carrier is sent from the hydrogen carrier supply unit 11 to the hydrogen generation unit 12 by its own weight, and the amount of the hydrogen carrier to be supplied can be adjusted by an on-off valve attached to the hydrogen generation unit 12. The storage container is preferably made of metal from the viewpoint of preventing static electricity, but there is no particular problem even if the storage container is made of a resin with electrostatic protection.

### [Water Supply Unit]

The water supply unit 21 has a function of supplying the “water-containing liquid” from a tap, a water tank, or the like, and a filter or the like is installed in a flow path in order to remove foreign matters and the like. In addition, for the purpose of promoting or stabilizing the hydrolysis reaction, the water supply unit 21 may have a function of adjusting a temperature of the water-containing liquid to be supplied, such as a heater or a chiller. The amount of the water-containing liquid to be supplied can be adjusted by an on-off valve attached to the hydrogen generation unit 12.

### [Hydrogen Generation Unit]

The hydrogen generation unit 12 has a function of generating hydrogen by the hydrolysis reaction between the hydrogen carrier and the water-containing solution. The hydrogen generation unit 12 includes a reaction unit (for example, a container) 12a that reacts with the hydrogen carrier and the water-containing solution. In the case of generating hydrogen, the hydrogen carrier is first supplied to the reaction unit 12a from the hydrogen carrier supply unit 11, and the water-containing liquid is also supplied to the reaction unit 12a from the water supply unit 21. Next, in the reaction unit 12a, the hydrogen carrier and water are mixed. A stirring blade or the like for promoting mixing is attached to the reaction unit 12a so that the mixing of the hydrogen carrier and the water-containing liquid can be smoothly performed.

As the hydrogen carrier and the water-containing liquid are mixed in the reaction unit 12a, the hydrolysis reaction occurs and hydrogen is generated. Since the generated hydrogen moves upward in the reaction unit 12a, a hydrogen discharge port is installed at an upper portion of the reaction unit 12a. The hydrogen discharge port is connected to the external fuel cell system 22, and the hydrogen generated in the reaction unit 12a is sent to the fuel cell system 22.

On the other hand, a discharge port for discharging the liquid containing the byproduct and water, which is generated by the hydrolysis reaction, is provided at a lower portion of the reaction unit 12a. An on-off valve is provided at the discharge port, and the liquid containing the byproduct and water, which is generated in the reaction unit 12a, gathers at the lower portion, and in a case where the on-off valve is opened, the byproduct and the water-containing liquid are sent to the collection container 14 through the discharge port.

The on-off valve is closed at the time of hydrogen generation, and is opened at a timing at which the hydrogen generation is settled. As for an opening/closing timing of the on-off valve, an appropriate timing can be determined by measuring the amount of the supplied hydrogen carrier, the amount of the generated hydrogen, and the like.

The reaction unit 12a of the hydrogen generation unit 12 is required to have heat resistance in consideration of heat generation and the like caused by the hydrolysis reaction. In addition, in order to prevent ignition of generated hydrogen, it is required that static electricity can be prevented. Therefore, an inner wall of the reaction unit 12a is preferably made of metal.

In order to promote the hydrolysis reaction, an apparatus for heating a mixed solution of the hydrogen carrier and water may be added to the hydrogen generation unit 12. In addition, the hydrogen generation unit 12 may have a conveyance unit such as a screw conveyor or a conveyor belt for conveying the hydrogen carrier therein, and may be configured to supply the water-containing liquid to the hydrogen carrier conveyed by the conveyance unit.

### [Detection Unit]

The detection unit 13 is a sensor installed in the collection container 14, and has a function of detecting the amount of the composition containing the byproduct (the liquid containing the byproduct and water in the present embodiment), which is accumulated in the collection container 14, that is, the collected amount of the composition collected from the hydrogen generation unit 12. Specifically, the sensor used as the detection unit 13 is, for example, an ultrasonic sensor, a radio wave sensor, a laser sensor, a capacitance sensor, or the like that senses a position of a liquid level of the composition inside the collection container 14. The detection unit 13 sends information regarding the detected collected amount to the control unit 15.

In the control unit 15, as described below, such information is used for processing such as calculation of the byproduct, the remaining storage capacity, and a warning indicator indicating the OVER state of the collected amount (storage amount). That is, the control unit 15 calculates a volume of the composition containing the byproduct in combination with information such as container information based on the information detected by the detection unit 13.

In addition, the detection unit 13 may be of a weight-based type that measures a weight of the collection container 14 including contents thereof. Such a type calculates a weight of the composition containing the byproduct based on an increase or decrease in weight. In any of the sensors, information such as the amount of the composition containing the byproduct, the amount of the byproduct, and the remaining storage capacity can be calculated by using a measured capacity or weight information in combination with reaction information of the hydrogen carrier and the water-containing liquid in the hydrogen generation unit 12.

Furthermore, as the detection unit 13, a digital count type or the like can also be used. The digital count type is a type that predicts the amount of the composition containing the byproduct obtained by removing hydrogen from the reaction information of the hydrogen carrier and the water-containing liquid in the hydrogen generation unit 12. The amount of the generated hydrogen can be predicted from the amount of the hydrogen carrier, and the amount of the water-containing liquid can be grasped, so that the amount of the composition containing the byproduct can also be predicted. However, in this method, information such as moisture evaporation after collection cannot be supplemented, and thus, the method is less accurate than the above-method using the sensor.

### [Collection Container]

The collection container 14 is a container capable of storing the composition containing the byproduct, which is sent from the hydrogen generation unit 12, such as the liquid containing the byproduct and the unreacted water, and is a container attachable to and detachable from the main body 10 of the hydrogen generation apparatus 1. That is, the collection container 14 is attachable to and detachable from the main body 10, and collects the composition containing the byproduct generated together with hydrogen in the hydrogen generation unit 12.

In addition, the collection container 14 includes the memory 17 serving as a storage unit that stores the information regarding the collected amount in the collection container 14. The memory 17 is provided on the collection container 14. The information regarding the collected amount is information such as the amount of the composition containing the byproduct, the amount of the byproduct, or the remaining storage capacity. In addition, such information may include identification information unique to the individual collection container 14, which is required in the case of storing information such as the amount of the composition containing the byproduct, the amount of the byproduct, or the remaining storage capacity in information collection equipment.

The memory 17 is, for example, a nonvolatile memory. Examples of the nonvolatile memory include a semiconductor memory such as an electrically erasable programmable read-only memory (EEPROM) or a flash memory, a magnetically rewritable magnetic tape medium, and a ferroelectric memory such as a ferroelectric random access memory (FeRAM), and any of them can be used. The memory 17 is preferably readable from the outside, and is preferably readable by reading equipment such as a generally used radio frequency identification (RFID) reader, for example, an RFID tag.

A reader/writer 18 of the memory 17 for reading and writing from and to the memory 17 is installed in the main body 10. The reader/writer 18 is connected to the control unit 15, and information regarding the collection container, which is measured by the detection unit 13, is transmitted to the control unit 15, and the control unit 15 can store the information in the memory 17 via the reader/writer 18.

The identification information unique to each individual collection container 14 refers to, for example, a kind of lot number for each container. Any method may be used to indicate the identification information, including numbers, letters, symbols, barcodes, or two-dimensional codes. The identification information is transmitted to the control unit 15 using, for example, light receiving equipment such as image recognition, a laser system or the like, or input through a keyboard or the like.

A material of the collection container 14 is not particularly limited, and either a metal collection container 14 or a resin collection container 14 may be used without any particular problem. However, the byproduct may have flammability depending on a type of the hydrogen carrier used. In this case, it is preferable to use a metal container or a resin container with electrostatic protection from the viewpoint of electrostatic prevention. In a case where the hydrolysis reaction of the hydrogen carrier and the water-containing liquid is an exothermic reaction, it is preferable to use a heat-resistant container. Furthermore, a shape of the collection container 14 is not particularly limited, but there is no particular problem as long as the sensor used in the detection unit 13 functions without any problem.

### [Control Unit]

The control unit 15 includes a central processing unit (CPU) 15a, a random access memory (RAM), a storage, a communication interface, a signal transmission unit, a signal reception unit, and the like. The control unit 15 has a function of receiving information such as the reaction ratio obtained by the hydrogen generation apparatus 1 and information such as a required amount of hydrogen from the fuel cell system or the like, transmitting a control command to the entire hydrogen generation apparatus, and transmitting computed information to the display unit 16 and the fuel cell system 22. The remaining storage capacity of the collection container 14 and a warning indicating the OVER state of the collected amount is displayed on the display unit 16 based on the information transmitted from the control unit 15. The memory 17 of the collection container 14 stores information such as the amount of the composition containing the byproduct and the amount of the byproduct based on the information transmitted from the control unit 15.

The CPU 15a serving as a calculation unit calculates the amount of the byproduct contained in the composition collected in the collection container 14 based on the collected amount of the composition, the collected amount being detected by the detection unit 13. Specifically, the CPU 15a calculates the amount of the byproduct based on the reaction ratio between the hydrogen carrier and the water-containing liquid and the collected amount of the composition, the collected amount being detected by the detection unit 13. The control unit 15 stores the amount of the byproduct calculated by the CPU 15a in the memory 17 provided in the collection container 14. That is, the information regarding the collected amount stored in the memory 17 includes the amount of the byproduct calculated by the CPU 15a.

### [Display Unit]

The display unit 16 has a function of receiving and displaying information regarding the hydrogen generation unit 12, the detection unit 13, and the collection container 14 through the control unit 15. In particular, in the present embodiment, the display unit 16 can display information regarding the storage capacity of the collection container 14. The information regarding the storage capacity is at least one of a collectable amount of the composition in the collection container 14 at a corresponding time point and information indicating that the collected amount of the composition in the collection container 14 has exceeded a predetermined amount (the warning indicating the OVER state of the collected amount). Furthermore, the information regarding the storage capacity may be information regarding a replacement time of the collection container 14 at the corresponding time point (remaining storage capacity).

That is, the display unit 16 is not particularly limited as long as the display unit 16 can display information such as the amount of the composition containing the byproduct collected in the collection container 14, the amount of the byproduct, the remaining storage capacity, and the warning indicating the OVER state of the collected amount. In addition, all of these pieces of information may be displayable, or any one piece of information may be displayable. The remaining storage capacity indicates the amount of the composition that can still be stored in the collection container 14. In addition, the amount of the composition, the amount of the byproduct, and the remaining storage capacity may be indicated by numerical values, or may be indicated by figures such as a bar graph and a circular graph.

In addition, the “predetermined amount” in the information indicating that the collected amount of the composition in the collection container 14 has exceeded the predetermined amount is, for example, an amount set in advance to be smaller than a full capacity so that the collected composition does not overflow from the collection container 14. The control unit 15 stops the operation of the hydrogen generation apparatus 1 at a time point at which the warning indicating the OVER state of the collected amount is issued.

The “predetermined amount” described above may be an amount set in advance, for example, in consideration of a period from when the information is displayed until when it is assumed that the next collection container 14 can be prepared. In this way, it is possible to shorten an operation stop period of the hydrogen generation apparatus 1 until replacement with the next collection container 14. In this case, after the information is displayed at a time point at which the predetermined amount is exceeded, the information indicating that the collection container 14 is full is displayed again at a time point at which the collected amount becomes close to full capacity, and at this time point, it is preferable to stop the operation of the hydrogen generation apparatus 1.

In addition, the information regarding the replacement time of the collection container 14 may be, for example, information obtained by estimating a timing to replace the collection container based on the past usage history and the remaining storage capacity and expressing the timing as, for example, a replacement date or a time remaining until replacement, in addition to the remaining storage capacity described above. In addition, in the case of warning information, instead of the display unit or in addition to the display unit, a method of notifying by sound may be used.

It is sufficient if a display method of the display unit 16 is at least one of an indicator on a display such as a liquid crystal display or an LED display, or a simple indicator such as a fluorescent display tube, a liquid crystal indicator, or an LED indicator Furthermore, the display unit 16 may be capable of displaying the amount by meters or the like. In addition, in the case of the warning indicator, an LED lamp, a rotating beacon, or a speaker that emits a warning sound may be used without any particular problem.

### EXAMPLE

Next, an example (example) of a specific example of the present embodiment described above will be described. In the present example, a weight sensor was used as the detection unit 13, and a readable and writable radio frequency identification (RFID) tag was used as the memory 17 incorporated in the collection container 14. The hydrogen carrier was sodium borohydride. In the present example, an operation of displaying the OVER state of the collected amount of the composition containing the byproduct in the hydrogen generation apparatus 1 with the configuration on the display unit 16 is described in detail.

First, sodium borohydride is supplied from the hydrogen carrier supply unit 11, and water is supplied from the water supply unit 21. At this time, the amount of supplied sodium borohydride and the amount of supplied water are determined based on a predetermined ratio. The information is sent to the control unit 15. Next, in the hydrogen generation unit 12, sodium borohydride and water are stirred to cause the hydrolysis reaction, as a result of which hydrogen is generated. Once the reaction is completed, a solution of sodium metaborate as the byproduct and water is sent to the collection container 14.

Since the weight sensor serving as the detection unit 13 measures a weight for each collection container 14, a weight change amount (measured value-container weight) is measured as the amount of the solution of sodium metaborate, information regarding the amount of the solution of sodium metaborate is sent to the control unit 15, and the amount of sodium metaborate (the amount of the byproduct) and the amount of water are calculated according to a reaction ratio between the amount of sodium borohydride and the amount of water. A calculation method thereof is described with reference to Tables 1 and 2.

TABLE 1

| Component | NaBH₄ | 2H₂O | ⇒ | NaBO₂ | 4H₂ |
|---|---|---|---|---|---|
| Molecular | 37.83 | 2 × 18.015 | | 65.8 | 4 × 2.016 |
| weight ratio | | | | | |
| Weight ratio | 1 | 0.952 | | 1.739 | 0.213 |
| (with NaBH₄ set as 1) | | | | | |
| Volume ratio | 1/1.07 | 0.952/0.997 | | 1.739/2.46 | 0.213/9E−5 |

TABLE 2

| Component | NaBH₄ | H₂O(supplied) | ⇒ | NaBO₂ | H₂ | H₂O(collected) | NaBO₂ solution |
|---|---|---|---|---|---|---|---|
| Weight ratio | A | B | | 1.739A | 0.213A | −0.952A + B | 0.787A + B |

Table 1 shows a weight ratio of each component calculated from a molecular weight of each component in the reaction of Chemical Formula (1) described above and a volume ratio obtained by dividing the weight ratio by each specific gravity. In the actual hydrogen generation apparatus 1, a large amount of water is often added in order to facilitate the hydrolysis reaction, and Table 2 shows a weight ratio of each component in a case where such a reaction is assumed. Here, the amount of supplied sodium borohydride (NaBH₄) was set to A, and the amount of supplied water (H₂O) was set to B.

That is, Table 2 shows that, if a ratio between supplied sodium borohydride (NaBH₄) and supplied water (H₂O) is known, the weight of sodium metaborate (NaBO₂) and the weight of water (H₂O) can be calculated from the amount of the sodium metaborate solution measured by the detection unit 13, sodium metaborate and water being components of the collected composition (sodium metaborate solution). In addition, since the specific gravity of each component is also roughly known, the volumes of sodium metaborate and water can also be calculated. In addition, in a case where an additive such as a catalyst or a pH adjuster is contained in sodium borohydride or water to be supplied, it is sufficient if the calculation is performed separately from the above formula, and if the additive changes the reaction formula, it is sufficient if the same calculation as above is performed using a new formula.

At this time, there is no problem even if the sensor of the detection unit 13 does not measure the weight but indirectly measures the volume like a liquid level sensor, and it is only required to calculate the weight by using the specific gravity of each component based on the volume calculated using shape information and the measured value of the storage container.

Next, the weight of sodium metaborate, the weight of water, the weight of the sodium metaborate solution, and the volume of the sodium metaborate solution, which are calculated by the CPU 15a of the control unit 15, are stored in the memory 17 incorporated in the collection container 14. At this time, in a case where the volume of the sodium metaborate solution exceeds a certain amount with respect to the volume of the collection container 14, a warning indicating the OVER state of the collected amount can be displayed on the display unit 16. It is also possible to always display the remaining collection capacity of the collection container 14 on the display unit 16 based on information regarding the volume of the collection container 14 and the volume of the sodium metaborate solution.

In the present embodiment, there is no problem even if moisture in the collection container 14 is partially evaporated in a case where the hydrogen generation apparatus 1 is stopped for a long period of time. Since information indicating that the last operation of the hydrogen generation apparatus 1 remains in the memory 17 of the collection container 14, a difference between the newly measured amount of the sodium metaborate solution and the amount of the sodium metaborate solution in the memory 17 is counted as a decrease in amount of water, and the current weight of sodium metaborate, the current weight of water, the current weight of the sodium metaborate solution, and the current volume of the sodium metaborate solution can be calculated again.

Even in a case where the collection container 14 is replaced with another collection container 14 in use, it is possible to calculate the current weight of sodium metaborate, the current weight of water, the current weight of the sodium metaborate solution, and the current volume of the sodium metaborate solution based on the information in the memory 17, as in a case where the hydrogen generation apparatus 1 is stopped for a long period of time.

In the present embodiment, it is possible to grasp the collected amount in the collection container 14 for collecting the composition containing the byproduct generated at the time of hydrogen production. That is, the amount of the composition collected in the collection container 14 is detected by the detection unit 13 and stored in the memory 17. Therefore, the amount of the composition stored in the collection container 14 can be grasped by reading the information stored in the memory 17. Therefore, the replacement timing of the collection container 14 can be grasped, and for example, the composition can be prevented from overflowing from the collection container 14. In addition, even in a case where the collection container 14 in which the composition has been partially collected is used in another apparatus, it is possible to grasp how much composition is stored in the collection container 14 from the information in the memory 17, and thus, even if the collection container 14 is used midway in another apparatus, it is possible to prevent the composition from overflowing from the collection container 14.

In addition, if the control unit 15 calculates the amount of the byproduct from the composition and stores the information in the memory 17 of the collection container 14, the information is useful in a case where the byproduct is reused. For example, in a case where the byproduct is sodium metaborate, if the amount of sodium metaborate stored in the collection container 14 is known, it is possible to grasp how much sodium borohydride can be regenerated at the time of regeneration into sodium borohydride. In addition, sodium metaborate can be used not only for regenerating sodium borohydride but also for other uses, and may be commercially traded. In this case, if the amount of sodium metaborate stored in the collection container 14 is known, the amount of sodium metaborate can be used for calculation of the amount of money at the time of commercial trading.

### Second Embodiment

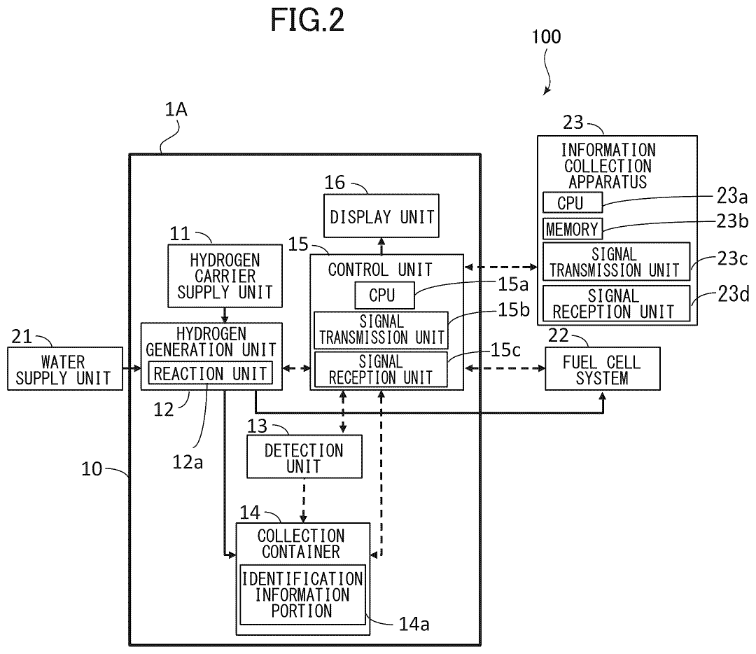

A second embodiment will be described with reference to FIG. 2. In the first embodiment described above, information regarding the collected amount of the composition is stored in the memory 17 of the collection container 14. On the other hand, in the present embodiment, information regarding identification of a collection container 14 and information regarding a collected amount detected by a detection unit 13 are transmitted to an information collection apparatus 23 provided outside a hydrogen generation apparatus 1A, and the information collection apparatus 23 manages a collected amount of a composition stored in the collection container 14. Other configurations and operations are the same as those of the first embodiment described above, and thus, the same reference numerals are given to the same configurations to omit or simplify the description, and hereinafter, differences from the first embodiment will be mainly described.

Similarly to the configuration of the first embodiment, the hydrogen generation apparatus 1A of the present embodiment includes a main body 10, a hydrogen carrier supply unit 11, a hydrogen generation unit 12, a detection unit 13, a collection container 14, a control unit 15, and a display unit 16. A water supply unit 21 and a fuel cell system 22 are connected to the hydrogen generation apparatus 1A as external mechanisms. Further, in the present embodiment, the information collection apparatus 23 is communicably connected to the hydrogen generation apparatus 1A. That is, in the present embodiment, an information management system 100 is implemented by communicably connecting the hydrogen generation apparatus 1A and the information collection apparatus 23.

The information collection apparatus 23 is, for example, an external terminal such as a personal computer connected to the hydrogen generation apparatus 1A, or an external server installed at a location different from a location where the hydrogen generation apparatus 1A is installed via an Internet line or the like. Such an information collection apparatus 23 has a function of acquiring information from the hydrogen generation apparatus 1A, storing the acquired information, and performing calculation based on the acquired information.

The collection container 14 is provided with an identification information portion 14a that is the information (that is, identification information unique to each individual collection container 14) regarding identification of the collection container 14. In the present embodiment, unlike the first embodiment, the information regarding the collected amount of the composition collected in the collection container 14 is not stored in the collection container 14. Therefore, the identification information portion 14a only needs to be able to identify the collection container 14, and may be, for example, a number assigned to each container. In this case, for example, a sheet on which a number or the like is printed may be attached to the collection container 14, or the number may be directly printed on a surface of the collection container 14.

That is, the identification information unique to the individual collection container 14 in the present embodiment refers to, for example, a kind of lot number for each container. Any method may be used to indicate the identification information, including numbers, letters, symbols, barcodes, or two-dimensional codes. The identification information is transmitted to the control unit 15 using, for example, light receiving equipment such as image recognition, a laser system or the like, or input through a keyboard or the like, and is further transmitted to the information collection apparatus 23. The identification information portion 14a may include a memory that stores the information regarding identification of the collection container 14. In this case, for example, the memory is preferably readable from the outside, like an RFID tag.

Similarly to the first embodiment, the control unit 15 includes a CPU 15a serving as a calculation unit, a RAM, and the like, and has a function of receiving information such as a reaction ratio obtained by the hydrogen generation apparatus 1A and information such as a required amount of hydrogen from the fuel cell system or the like, transmitting a control command to the entire hydrogen generation apparatus, and transmitting computed information to the display unit 16, the fuel cell system 22, and the information collection apparatus 23.

FIG. 2 illustrates a signal transmission unit 15b serving as a transmission unit and a first transmission unit, and a signal reception unit 15c serving as a second reception unit. The signal transmission unit 15b transmits, to the information collection apparatus 23, the information regarding the collected amount of the composition collected in the collection container 14, which is detected by the detection unit 13, and the information regarding identification of the collection container 14 described in the identification information portion 14a of the collection container 14. The signal reception unit 15c can receive information transmitted from the information collection apparatus 23.

The information collection apparatus 23 includes a CPU 23a, a memory 23b serving as a storage unit, a signal transmission unit 23c serving as a second transmission unit, and a signal reception unit 23d serving as a reception unit and a first reception unit. The CPU 23a controls the entire information collection apparatus 23. The signal reception unit 23d receives information transmitted from the signal transmission unit 15b of the hydrogen generation apparatus 1A. The memory 23b stores the information regarding the collected amount of the composition collected in the collection container 14 in association with the collection container 14 based on the information received by the signal reception unit 23d. In addition, in a case where the collection container 14 is replaced, the information collection apparatus 23 stores, in the memory 23b, the information regarding the collected amount received by the signal reception unit 23d after replacement as information regarding the collection container 14 after replacement based on the information regarding identification of the collection container 14.

The CPU 15a of the hydrogen generation apparatus 1A calculates an amount of a byproduct contained in the composition collected in the collection container 14 based on the information regarding the collected amount in the collection container 14 detected by the detection unit 13 and the information regarding identification of the collection container 14. A calculation method in this case is similar to the calculation method performed by the CPU 15a of the control unit 15 in the first embodiment. A calculation result of the CPU 15a is transmitted to the information collection apparatus 23 via the signal transmission unit 15b and stored in the memory 23b of the information collection apparatus 23.

The amount of the byproduct contained in the composition may be calculated by the CPU 23a of the information collection apparatus 23. That is, the CPU 23a may calculate the amount of the byproduct contained in the composition collected in the collection container 14 based on the information regarding the collected amount in the collection container 14 and the information regarding identification of the collection container 14, which are transmitted from the hydrogen generation apparatus 1A. In this case, the CPU 23a stores the calculated amount of the byproduct in the memory 23b.

In any case, the memory 23b of the information collection apparatus 23 stores the information regarding the collected amount including the amount of the byproduct contained in the composition collected in the collection container 14. The signal transmission unit 23c of the information collection apparatus 23 can transmit the information regarding the collected amount stored in the memory 23b and the information regarding identification of the collection container 14 to the signal reception unit 15c of the hydrogen generation apparatus 1A.

The display unit 16 of the hydrogen generation apparatus 1A displays information regarding a storage capacity of the collection container 14 based on the information received by the signal reception unit 15c. That is, as in the first embodiment, the display unit 16 can display information such as an amount of the composition containing the byproduct collected in the collection container 14, the amount of the byproduct, a remaining storage capacity, and a warning indicating an OVER state of the collected amount. The calculation of the storage capacity may be performed by the CPU 15a of the hydrogen generation apparatus 1A as in the first embodiment, or may be performed by the CPU 23a of the information collection apparatus 23.

The information regarding the storage capacity displayed on the display unit 16 is, as in the first embodiment, at least one of the amount of the composition collectable in the collection container 14 at a corresponding time point and information indicating that the collected amount of the composition in the collection container 14 has exceeded a predetermined amount, or information regarding a replacement time of the collection container at the corresponding time point. The other contents related to the display unit 16 are similar to those of the first embodiment.

Next, an example of a specific example of the present embodiment will be described. In the present embodiment, first, the control unit 15 recognizes the identification information of each collection container individual by reading the identification information of the collection container 14. Thereafter, the hydrogen generation apparatus 1A starts to operate, and sodium borohydride and water are supplied to the hydrogen generation unit 12, whereby a hydrolysis reaction occurs, and a waste fuel (the composition containing the byproduct, such as a sodium metaborate solution in the present embodiment) after the reaction is sent to the collection container 14.

Here, as in the first embodiment, information regarding the reaction ratio, weight information of the sodium metaborate solution, and the like are sent to the control unit 15. Thereafter, the CPU 15a calculates a weight of sodium metaborate, a weight of water, a weight of the sodium metaborate solution, a volume of the sodium metaborate solution, and the like. Then, such information is associated with the identification information of the collection container 14, transmitted to the information collection apparatus 23 via the Internet or the like, and stored.

In a case where the hydrogen generation apparatus 1A is stopped for a long period of time or the collection container 14 is replaced with another collection container 14 in use, the control unit 15 of the hydrogen generation apparatus 1A acquires the information from the information collection apparatus 23 based on the identification information of the collection container 14, so that it is possible to recalculate the current weight of sodium metaborate, the current weight of water, the current weight of the sodium metaborate solution, and the current volume of the sodium metaborate solution as in the first embodiment.

In addition, in the present embodiment, by sending an installation location information of each hydrogen generation apparatus 1A and the like to the information collection apparatus 23, it is possible to know replacement timings of the collection containers 14 of the hydrogen generation apparatuses 1A at a plurality of locations, and thus, for example, it is also possible to utilize the replacement timings to assume an optimal route for delivering the collection container 14 for replacement or the used collection container 14.

Also in the present embodiment, it is possible to grasp the collected amount in the collection container 14 for collecting the composition containing the byproduct generated at the time of hydrogen production. That is, in the present embodiment, the information regarding the collected amount in the collection container 14 is sent together with the identification information of the collection container 14 to the information collection apparatus 23, so that the information collection apparatus 23 can manage each collection container 14. Therefore, the control unit 15 of the hydrogen generation apparatus 1A can acquire information regarding the collection container 14 by appropriately acquiring information from the information collection apparatus 23, and can appropriately grasp the collected amount in the collection container 14 even in a case where the collection container 14 is replaced, for example.

Further, in the present embodiment, the plurality of hydrogen generation apparatuses 1A installed at different locations can be centrally managed by the information collection apparatus 23, and for example, by monitoring the information regarding the collection container 14 used in each hydrogen generation apparatus 1A in real time, it becomes easy to appropriately determine the replacement time of each collection container 14, a delivery rule, and the like.

According to the present disclosure, it is possible to grasp a collected amount in a collection container for collecting a composition containing a byproduct generated at the time of hydrogen production.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A hydrogen generation apparatus comprising:
a hydrogen generation unit configured to generate hydrogen by reacting a hydrogen carrier with a water-containing liquid;
a main body including the hydrogen generation unit;
a collection container being attachable to and detachable from the main body and configured to collect a composition containing a byproduct generated together with hydrogen in the hydrogen generation unit;
a detection unit configured to detect a collected amount of the composition collected from the hydrogen generation unit by the collection container; and
a storage unit provided on the collection container and configured to store information regarding the collected amount.

2. The hydrogen generation apparatus according to claim 1, further comprising a calculation unit configured to calculate an amount of the byproduct contained in the composition collected in the collection container based on the collected amount detected by the detection unit,
wherein the information regarding the collected amount includes the amount of the byproduct calculated by the calculation unit.

3. The hydrogen generation apparatus according to claim 2, wherein the calculation unit calculates the amount of the byproduct based on a reaction ratio between the hydrogen carrier and the water-containing liquid, and the collected amount detected by the detection unit.

4. The hydrogen generation apparatus according to claim 1, further comprising a display unit configured to display information regarding a storage capacity of the collection container.

5. The hydrogen generation apparatus according to claim 4, wherein the information regarding the storage capacity is at least one of a collectable amount of the composition in the collection container at a corresponding time point and information indicating that the collected amount of the composition in the collection container has exceeded a predetermined amount.

6. The hydrogen generation apparatus according to claim 4, wherein the information regarding the storage capacity is information regarding a replacement time of the collection container at the corresponding time point.

7. The hydrogen generation apparatus according to claim 1, wherein
the hydrogen carrier is sodium borohydride, and
the byproduct is sodium metaborate.

8. An information management system comprising:
a hydrogen generation apparatus configured to generate hydrogen; and
an information collection apparatus being communicably connected to the hydrogen generation apparatus, wherein
the hydrogen generation apparatus includes:
a hydrogen generation unit configured to generate hydrogen by reacting a hydrogen carrier with a water-containing liquid;
a main body including the hydrogen generation unit;
a collection container being attachable to and detachable from the main body and configured to collect a composition containing a byproduct generated together with hydrogen in the hydrogen generation unit;
an identification information portion provided on the collection container, the identification information portion being information regarding identification of the collection container;
a detection unit configured to detect a collected amount of the composition collected from the hydrogen generation unit by the collection container; and
a transmission unit configured to transmit information regarding the collected amount and the information regarding identification of the collection container, and
the information collection apparatus includes:
a reception unit configured to receive the information transmitted from the transmission unit; and
a storage unit configured to store the information regarding the collected amount in association with the collection container based on the information received by the reception unit.

9. The information management system according to claim 8, wherein in a case where the collection container is replaced, the information collection apparatus stores, in the storage unit, the information regarding the collected amount received by the reception unit after replacement as information regarding the collection container after replacement, based on the information regarding identification of the collection container.

10. The information management system according to claim 8, wherein
the hydrogen generation apparatus further includes a calculation unit configured to calculate an amount of the byproduct contained in the composition collected in the collection container based on the information regarding the collected amount and the information regarding identification of the collection container, and
the information regarding the collected amount includes the amount of the byproduct calculated by the calculation unit.

11. The information management system according to claim 8, wherein
the transmission unit is a first transmission unit,
the reception unit is a first reception unit,
the information collection apparatus further includes a second transmission unit configured to transmit the information regarding the collected amount, which is stored in the storage unit, and the information regarding identification of the collection container, and
the hydrogen generation apparatus further includes:
a second reception unit configured to receive the information transmitted from the second transmission unit; and
a display unit configured to display information regarding a storage capacity of the collection container based on the information received by the second reception unit.

12. The information management system according to claim 11, wherein the information regarding the storage capacity is at least one of a collectable amount of the composition in the collection container at a corresponding time point and information indicating that the collected amount of the composition in the collection container has exceeded a predetermined amount.

13. The information management system according to claim 11, wherein the information regarding the storage capacity is information regarding a replacement time of the collection container at the corresponding time point.

14. The information management system according to claim 8, wherein
the hydrogen carrier is sodium borohydride, and
the byproduct is sodium metaborate.
